(19) United States
(12) Patent Application Publication
(10) Pub. No.: US 2014/0201617 A1
(43) Pub. Date: Jul. 17, 2014

(54) Method for Browsing Web Page on Mobile Terminal

(71) Applicant: Jie Liang, Guangdong (CN)

(72) Inventor: Jie Liang, Guangdong (CN)

(73) Assignee: GUANGZHOU UCWEB COMPUTER TECHNOLOGY CO., LTD, Guangzhou City, Guangdong (CN)

(21) Appl. No.: 14/118,217

(22) PCT Filed: May 16, 2012
(86) PCT No.: PCT/CN2012/075597

§ 371 Date: Mar. 25, 2014

(30) Foreign Application Priority Data
May 16, 2011 (CN) 201110125841.1

(51) Int. Cl. G06F 17/22

(52) U.S. Cl. CPC G06F 17/2247
USPC 715/234

(57) ABSTRACT

A method for browsing a web page comprises receiving, at a proxy server, a web page download request from a mobile terminal to request download a web page, acquiring a basic file from a first target site, the basic file including path to a source file of the web page, parsing the basic file to obtain the path to the source file, acquiring the source file from a second target site based on the parse result, integrating the basic file and the source file to create an integration file and transmitting the integration file to the mobile terminal to cause the mobile terminal to parse and render the basic file and the source file.

### CROSS-REFERENCE TO RELATED APPLICATION

This application is the U.S. National Stage of PCT/CN/2012/075597, filed with WIPO on May 16, 2012, the entire content of which is incorporated herein by reference in its entirety.

### FIELD

The present invention generally relates to an inspection apparatus, method, and computer program product. More specifically, the invention relates to mobile terminal, method, and computer program product for browsing a web page.

### BACKGROUND

Client/Server (C/S) architecture and direct connect architecture have been widely used on mobile terminals. By using the C/S architecture, access to a Hypertext Markup Language (HTML) web page is implemented by accessing a web server. The HTML web page cannot be accessed by client directly. As such, page elements including Cascading Style Sheets (CSS), JavaScript and the like embedded in an HTML/Extensible HTML (XHTML) page cannot be well-supported. Heavy reliance upon the web server may result in instability caused by the web server. For example, an unexpected crash of the web server may cause access failure or failed download web pages. Since web pages are stored remotely, a web page may be acquired by reconnecting network when different layouts are used by one web page. For example, when page view is switched from zoom to fit-to-page, it may reconnect the web server to acquire the desired web page in fit-to-page layout. The reconnection to the web server may waste time and network flow. Direct connect architecture involves data transfer from one user to another without using a middleware server. Because data for transfer in direct connect architecture is not compressed, it may cause network congestion and performance deterioration.

### SUMMARY

Through applied effort, ingenuity, and innovation, solutions to improve a method for browsing a web page on a mobile terminal have been realized and are described herein. Mobile terminal, method, and computer program product for browsing a web page are described herein that provide improved browsing method to support CSS, JavaScript and the like embedded in an HTML/XHTML page.

According to one exemplary embodiment of the subject disclosure, a method is described. The method comprises receiving, at a proxy server, a web page download request from a mobile terminal to request download a web page and acquiring a basic file from a first target site. The basic file includes path to a source file of the web page. The method further comprises parsing the basic file to obtain the path to the source file, acquiring the source file from a second target site based on the parse result, integrating the basic file and the source file to create an integration file and transmitting the integration file to the mobile terminal to cause the mobile terminal to parse and render the basic file and the source file.

According to one exemplary embodiment of the subject disclosure, a proxy server is described. The proxy server comprises a basic file acquiring module configured to receive a web page download request from a mobile terminal to request download a web page and acquire a basic file from a first target site, the basic file including path to a source file of the web page. The proxy server further comprises a source file acquiring module configured to parse the basic file to obtain the path to the source file and acquire the source file from a second target site based on the parse result, an integration module configured to integrate the basic file and the source file to create an integration file and a transmission module configured to transmit the integration file to the mobile terminal to cause the mobile terminal parse and render the basic file and the source file.

According to one exemplary embodiment of the subject disclosure, a computer program product comprises a non-transitory computer readable storage medium and computer program instructions stored therein is described. The computer program instructions comprise program instructions configured to receive a web page download request from a mobile terminal to request download a web page and acquire a basic file from a first target site. The basic file includes path to a source file of the web page. The computer program instructions comprise program instructions configured to parse the basic file to obtain the path to the source file, acquire the source file from a second target site based on the parse result, integrating the basic file and the source file to create an integration file and transmit the integration file to the mobile terminal to cause the mobile terminal to parse and render the basic file and the source file.

### BRIEF DESCRIPTION OF THE DRAWINGS

Having thus described some embodiments in general terms, reference will now be made to the accompanying drawings, which are not necessarily drawn to scale. The embodiments illustrated in the figures of the accompanying drawings herein are by way of example and not by way of limitation, and wherein:

FIG. 1 is a flow chart illustrating a method for browsing a web page according to exemplary embodiments of the disclosure;

FIG. 2 illustrates a sequence diagram according to exemplary embodiments of the disclosure;

FIG. 3 illustrates a browsing effect by using a direct connect browser;

FIG. 4 illustrates a browsing effect by using an middleware browser;

FIG. 5 illustrates a browsing effect using an exemplary web browser according to exemplary embodiments of the disclosure; and

FIG. 6 illustrates a diagram of an exemplary proxy server according to exemplary embodiments of the disclosure.

### DETAILED DESCRIPTION

The subject disclosure now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In this regard, reference may be made herein to a number of mathematical or numerical expressions or values, and to a number of positions of various components, elements or the like. It should be understood, however, that these expressions, values, positions or the like may refer to absolute or approximate expressions, values or positions, such that exemplary embodiments may account for variations that may occur in the multi-channel optical cell, such as those due to engineering tolerances. Like numbers refer to like elements throughout.

As used herein, the word “exemplary” is used herein to refer to serving as an example, instance, or illustration. Any aspect, feature, function, design, etc. described herein as “exemplary” or an “example” or “examples” is not necessarily to be construed as preferred or advantageous over other aspects, features, functions, designs, etc. Rather, use of the word exemplary is intended to present concepts in a concrete fashion.

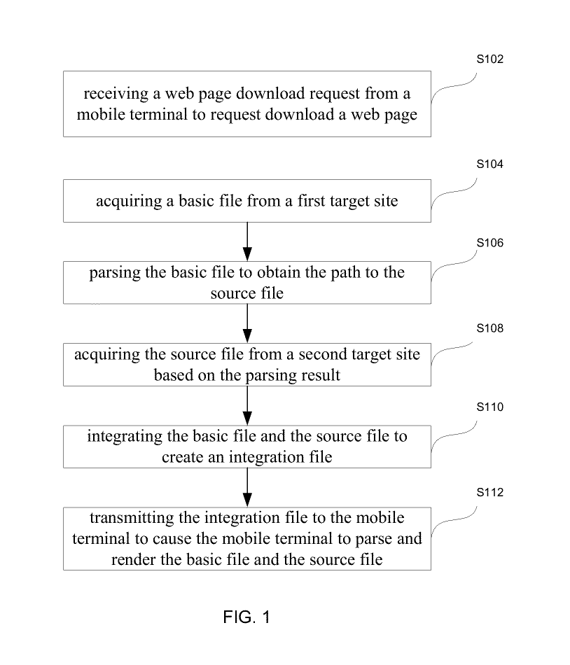

FIG. 1 illustrates a method for browsing a web page according to exemplary embodiments of the disclosure. A client may send a web page download request from a mobile terminal to a proxy server. When the proxy server receives the web page download request, it may request download a web page at step S102. The proxy server may acquire a basic file from a first target site at step S104. The basic file may be an HTML file or an XHTML file and may include path to a source file of the web page. The basic file may include descriptions associated with contents of the web page. At step S106, the proxy server may parses the basic file to obtain the path to the source file. At step S108, the proxy server may acquire the source file from a second target site based on the parse result. For example, when the basic file is an HTML file, the HTML file may include a plurality of tags. The proxy server may parse the tags to obtain a tag list. Some tags may not be associated with sources files thus may be removed from the tag list. Each of the remaining tags may be associated with a source file, for example, including the path to the source file. Based on the parse result, the proxy server may acquire the source file from the second target site. The second target site may be a server to store source files of a web page. The first target site may have the same address as the second target site. In another embodiment, the first target site may have different address than the second target site. For example, when client accesses http://www.sina.com.cn, home page of www.sina.com.cn is the first target site, namely the first web server. The home page may include a plurality of images saved on the first web server. To reduce server load, the images may be stored on a second target site, namely a resource server, as separate files.

After the proxy server acquires all desired source files, the proxy server may integrate the basic file and the source file to create an integration file at step S110. The integration may be implemented by applying a file compression tool, such as GZIP, WINRAR or other similar tools well known to one of ordinary skill in the art, to compress the basic file and the source file.

At step S112, the proxy server may transmit the integration file to the mobile terminal The mobile terminal may then parse and render the basic file and the source file. The proxy server may enable JavaScript in the web browser and implement PC page layout on the mobile terminal.

When a direct connect browser is used, client may send to a target site page download request to request download a web page and acquire a basic file. The basic file may be an HTML file of home page of, e.g., www.sina.com.cn. Mobile terminal may parse the basic file and acquire a desired source file from the target site based on the parse result. It may be repeated many times to acquire all of the desired source files. Mobile terminal may then render the basic file and the source file. The network flow may be about 873 KB and time consumption is about 93 seconds.

When a middleware browser is used, client may send from a mobile terminal to a proxy server page download request to request download a web page and acquire a basic file. The proxy server may parse the basic file and acquire desired source file from the target site based on the parse result. The proxy server may then compress the basic file and the desired source file and then send the compressed file to the mobile terminal. The mobile terminal may then render the basic file and the source file, and then display the source file on a display. The network flow may be about 400 kB and time consumption is about 50 seconds.

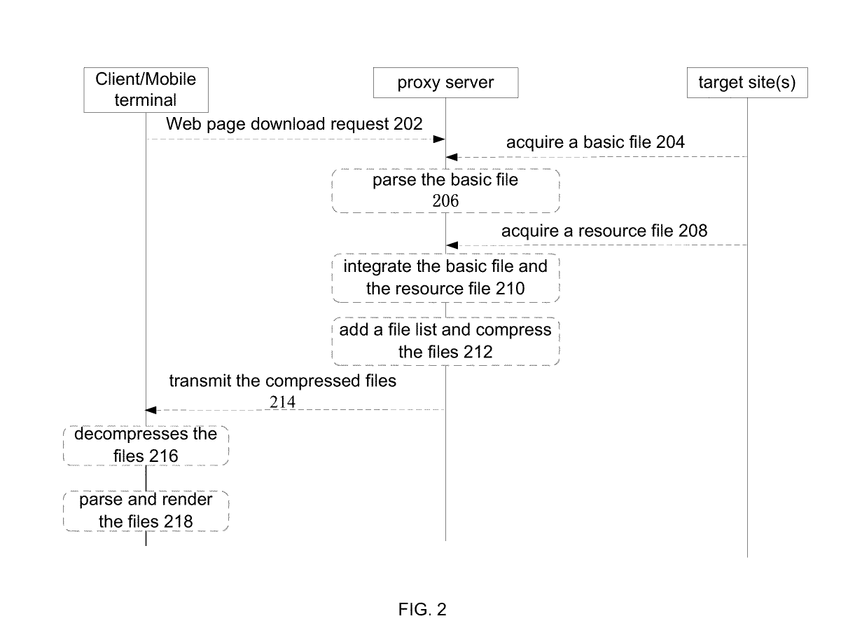

When an exemplary web browser according to exemplary embodiments of the disclosure is used, a client may send from a mobile terminal to a proxy server a web page download request at 202, as shown in FIG. 2. After the proxy server receives the web page download request to request download a web page, the proxy server may acquire a basic file from a first target site, e.g., www.sina.com.cn at 204. The proxy server may parse the basic file to obtain path to the source file at 206 and then acquire source file from a second target site at 208 based on the parse result. After the proxy server acquires all desired source files, the proxy server may integrate the basic file and the source file to create an integration file at 210. The proxy server may add a file list to the integration file and then compress the basic file and the source file at 212. The proxy server may then transmit the compressed integration file to the mobile terminal at 214. The mobile terminal may decompress the basic file and the source file at 216, parse and render the basic file and the source file at 218. When the mobile terminal parses the basic file and source file, the mobile terminal may search file name of a desired source file in the file list. If the file name of a desired source file is in the file list, client may directly use and render the source file without accessing the second target site. In contrast, if the file name of a desired source file is not in the file list, the mobile terminal may resend the web page download request to the second target website to acquire the desired source file. In this way, the traffic flow may be about 424 kB and the time consumption may be about 55 seconds.

Table 1 shows network flow and time consumption using direct connect browser, middleware browser and proxy server architecture browser:

TABLE 1
Technical parameters used in different browsers

| | Direct connect | | Middleware | | Exemplary | |
|---|---|---|---|---|---|---|
| Technical parameters | browser | | browser | | browser | |
| Network flow | >800 | kB | <400 | kB | ~400 | kB |
| Time consumption | >80 | seconds | <50 | seconds | ~50 | seconds |

By comparison, the exemplary browser may cause less network flow and higher access speed than the direct connect browser.

A web page source code is provided for respectively running on direct connect browser, middleware browser and exemplary browser of present disclosure. The web page includes two images. A JavaScript is used to display an image.

<html>

<head>
<meta charset=“utf-8”/>
<title>Panda</title>
</head>
<body>
<div align=“center”>

<img id=“one” src=“one.jpg”/>
<img id=“two” style=“display:none” src=“two.jpg”/><br/>

</div>
<div align=“center”>
<script>
function show(id)
{

one = document.getElementById(“one”);
two = document.getElementById(“two”);
info = document.getElementById(“info”);
if(id == 1) {

one.style.display = “”;
two.style.display = “none”;
info.innerHTML = “You clicked on the first image.”;

} else {

one.style.display = “none”;
two.style.display = “”;
info.innerHTML = “You clicked on the second image.”;

}

}
</script>
<p>

<a href=“javascript:show(1);”>first
image</a>&nbsp;&nbsp;&nbsp;&nbsp;&nbsp;
<a href=“javascript:show(2);”>second image</a>

</p>

<div id=“info”></div>

</div>
</body>

</html>

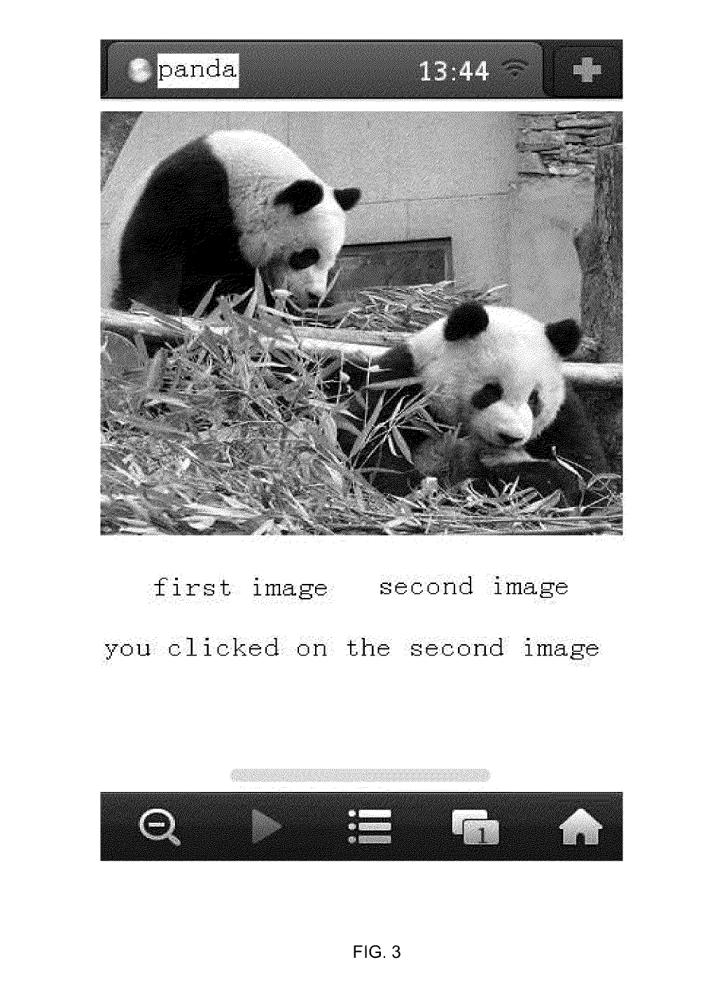

By running the source code on a direct connect browser, client may send to a target site page download request to request download a web page and acquire a basic file. The basic file includes the JavaScript. When the mobile terminal parses the basic file, the mobile terminal may identify that the JavaScript includes two images to display. The mobile terminal may resend the web page download request to acquire the two images by accessing the target site two times. The mobile terminal may then render the basic file and the source file. The image display effect is illustrated in FIG. 3. After the webpage is downloaded, the basic file and images are acquired and saved on the mobile terminal. The JavaScript may be executed to achieve interactions between user and internet. As described above, the network flow may be about 100.76 KB. The web browser may send web page download request to HTTP server and may send request to request resources of a web page, such as images, external JavaScript, CSS and the like. This may reduce the access speed.

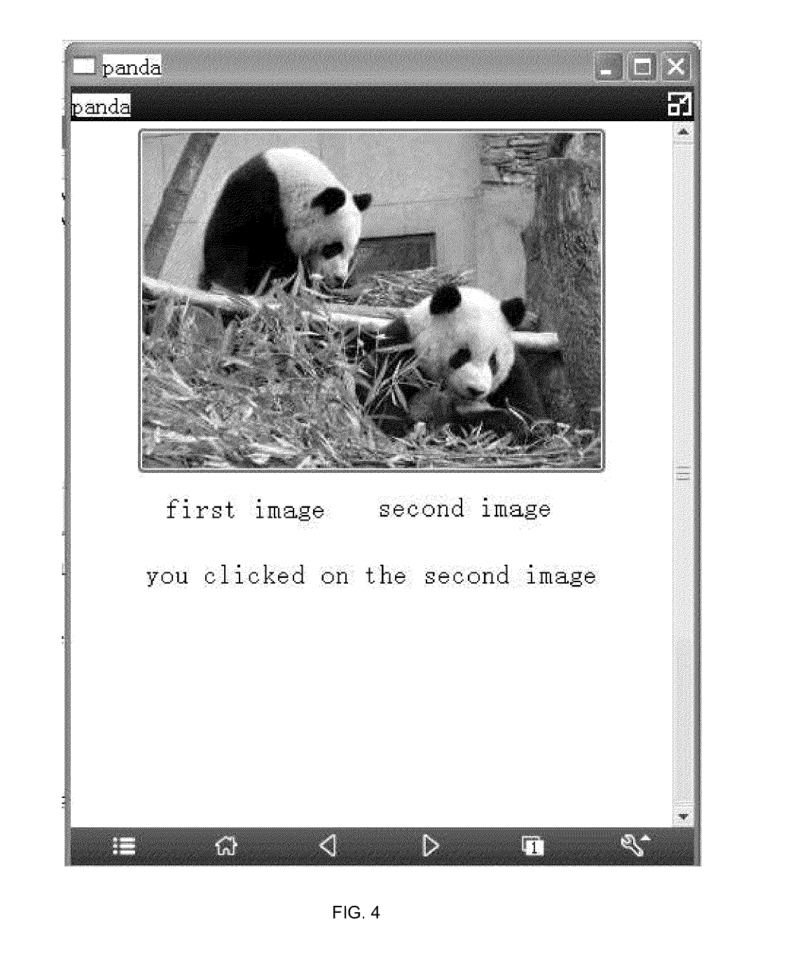

By running the source code on a middleware browser, client may send to a proxy server page download request to request download a web page and acquire a basic file. The basic file includes the JavaScript. The middleware server may parse the basic file and acquire desired source file from the target site based on the parse result. The source file may include two images. The middleware server may then compress the basic file and the desired source file, and send the compressed file to the mobile terminal. The mobile terminal may then render the basic file and the source file, and display the images on a display. The image display effect is illustrated in FIG. 4. Because the web page is compressed and resolution of the images is reduced the network flow may be reduced which may allow users to quickly access the web page. For example, the network flow may be reduced to 30.13 KB. Although web page created by JavaScript is dynamic the file that a mobile terminal receives is static because the basic file is parsed on server. Therefore, JavaScript may not be executed on a mobile terminal but on middleware sever. In this case, when user wants to display a different image, user may reconnect network to download the web page. Real time interaction between user and internet may be deteriorated.

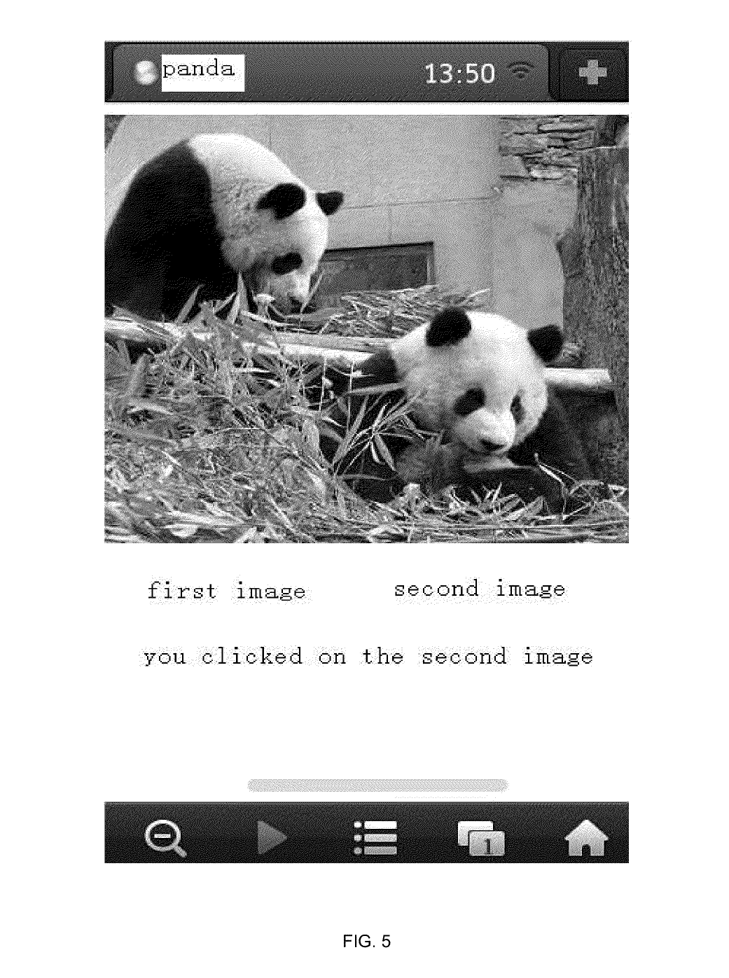

By running the source code on an exemplary browser of present disclosure, client may send to a first target site page download request to request download a web page and acquire a basic file. The basic file includes the JavaScript which may include two images to display. The proxy server may parse the basic file and acquire the two images from a second target site based on the parse result. The proxy server may integrate the basic file and the two images to create an integration file. The proxy server may add a file list to the integration file, compress the integration file and then transmit the compressed integration file to the mobile terminal. The mobile terminal may render decompress the integration file, parse and render the basic file and images. When the mobile terminal parses the JavaScript, it may identify that two images are included in the JavaScript. The mobile terminal may search the image names in the file list and determine if the images have been acquired and saved on the mobile terminal When the image is listed in the file list, the mobile terminal may acquire the image and render the image. The mobile terminal may otherwise resend the web page download request to the second target website to acquire the image. The second target site may be a server to store source files of a web page. The first target site may have the same address as the second target site. In another embodiment, the first target site may have different address than the second target site. The source file may include resources to render a desired web page, including script, tables and multi-media resources such as image files, external JavaScript and CSS files. The image display effect is illustrated in FIG. 5. By using the exemplary browser, network flow may be reduced to 46.07 KB. Because the proxy server parses the basic file and source file, and provides resources (e.g., images, external JavaScript and CSS files) for rendering a desired web page, the access speed may be enhanced by reducing the number of requests.

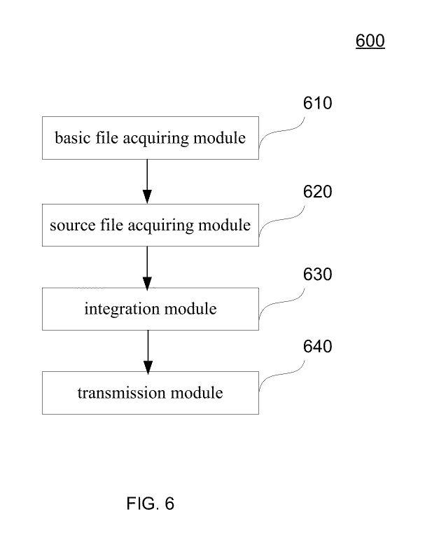

FIG. 6 illustrates a diagram of an exemplary proxy server 600 according to exemplary embodiments of the disclosure. The proxy server 600 may comprise a basic file acquiring module 610 to receive a web page download request from a mobile terminal to request download a web page, and acquire a basic file from a first target site. The basic file may include path to a source file of the web page. The proxy server 600 may comprise a source file acquiring module 620 to parse the basic file to obtain the path to the source file, and acquire the source file from a second target site based on the parse result. After the source file is acquired from the second target site, an integration module 630 may integrate the basic file and the source file to create an integration file. A transmission module 640 may then transmit the integration file to the mobile terminal to cause the mobile terminal parse and render the basic file and the source file. The proxy server 600 may further comprise an addition module (not shown) to add a file list to the integration file. The file list may comprise file names of source files that have been acquired.

It will be understood that each block or step of the flow chart, and combinations of blocks or steps in the flow chart, may be implemented by various means, such as hardware alone or in combination with firmware, and/or software including one or more computer program instructions. As will be appreciated, any such computer program instructions may be loaded onto a computer, special purpose computer, or other programmable data processing apparatus, such as proxy server illustrate in FIG. 2, to produce a machine, or machines, such that the computer program product includes the instructions which execute on the computer or other programmable data processing apparatus (e.g., hardware) to create means for implementing the functions described herein, such as the functions specified in the block(s) or step(s) of the flow chart of FIG. 1.

These computer program instructions may also be stored in a computer-readable storage device that may direct a computer or other programmable data processing apparatus to function in a particular manner, such that the instructions stored in the computer-readable storage device produce an article of manufacture including instruction computer-readable instructions for implementing the functions described herein, such as the functions specified in the block(s) or step(s) of the flow chart of FIG. 1. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions described herein, such as the functions specified in the block(s) or step(s) of the flow chart of FIG. 1.

Accordingly, blocks or steps of the flow chart support means and combinations of means for performing and/or implementing the specified functions, combinations of steps for performing and/or implementing the specified functions and program instruction means for performing and/or implementing the specified functions. It will also be understood that one or more blocks or steps of the flow chart, and combinations of blocks or steps in the flow chart, may be implemented by special purpose hardware-based computer systems which perform the specified functions or steps, or combinations of special purpose hardware and computer instructions.

It will be appreciated by those skilled in the art that changes could be made to the examples described above without departing from the broad inventive concept. It is understood, therefore, that this disclosure is not limited to the particular examples disclosed, but it is intended to cover modifications within the spirit and scope of the disclosure as defined by the appended claims. Although specific terms are employed herein, they are used in a generic and descriptive sense only and not for purposes of limitation.

1-10. (canceled)

11. A method for browsing a web page comprising:
receiving, at a proxy server, a web page download request from a mobile terminal to request download a web page;
acquiring a basic file from a first target site, the basic file including a path to a source file of the web page;
parsing the basic file to obtain the path to the source file;
acquiring the source file from a second target site based on the parse result;
integrating the basic file and the source file to create an integration file; and
transmitting the integration file to the mobile terminal to cause the mobile terminal to parse and render the basic file and the source file.

12. The method of claim 11, wherein the basic file comprises descriptions associated with contents of the web page.

13. The method of claim 12, wherein the basic file comprises Hypertext Markup Language (HTML) file and Extensible HTML (XHTML) file.

14. The method of claim 11, wherein the source file is configured to render the web page.

15. The method of claim 14, wherein the source file comprises at least one of a scripting language file, a Cascading Style Sheets (CSS) file and a multi-media source file.

16. The method of claim 15, wherein the multi-media source file comprises at least one of an image, a piece of music and a video.

17. The method of claim 11, further comprising adding a file list to the integration file, the file list comprising file name of each acquired source file.

18. The method of claim 17, further comprising causing the mobile terminal to search file name of the source file in the file list upon receipt of thew web page download request.

19. The method of claim 18, further comprising using the source file acquired by the proxy server in an instance in which the file name of the source file is in the file list.

20. The method of claim 18, further comprising resending the web page download request to the second target website to acquire the source file in an instance in which file name of the desired source file is not in the file list.

21. The method of claim 17, further comprising compressing the integration file and transmitting the compressed integration file to the mobile terminal.

22. A proxy server, comprising:
a basic file acquiring module configured to receive a web page download request from a mobile terminal to request download a web page and acquire a basic file from a first target site, the basic file including a path to a source file of the web page;
a source file acquiring module configured to parse the basic file to obtain the path to the source file and acquire the source file from a second target site based on the parse result;
an integration module configured to integrate the basic file and the source file to create an integration file; and
a transmission module configured to transmit the integration file to the mobile terminal to cause the mobile terminal parse and render the basic file and the source file.

23. The server of claim 22, further comprises an addition module configured to add a file list to the integration file, the file list comprising file name of each acquired source file.

24. A computer program product comprising a non-transitory computer readable storage medium and computer program instructions stored therein, the computer program instructions comprising program instructions configured to:
receive, at a proxy server, a web page download request from a mobile terminal to request download a web page;
acquire a basic file from a first target site, the basic file including a path to a source file of the web page;
parse the basic file to obtain the path to the source file;
acquire the source file from a second target site based on the parse result;
integrate the basic file and the source file to create an integration file; and
transmit the integration file to the mobile terminal to cause the mobile terminal to parse and render the basic file and the source file.

25. The computer program product of claim 24, wherein the computer program instructions is further configured to add a file list to the integration file, the file list comprising file name of each acquired source file.

26. The computer program product of claim 25, wherein the computer program instructions are further configured to cause the mobile terminal to search a file name of a desired source file in the file list upon receipt of a new web page download request.

27. The computer program product of claim 26, wherein the computer program instructions is further configured use the source file acquired by the proxy server in an instance in which the file name of the desired source file is in the file list.

28. The computer program product of claim 26, wherein the computer program instructions are further configured to resend the web page download request to the second target website to acquire the desired source file in an instance in which file name of the desired source file is not in the file list.

29. The computer program product of claim 26, wherein the computer program instructions are further configured to compress the integration file and transmitting the compressed integration file to the mobile terminal.
